(19) United States
(12) Patent Application Publication
(10) Pub. No.: US 2014/0046722 A1
(43) Pub. Date: Feb. 13, 2014

(54) SYSTEM FOR ON-SITE ENVIRONMENT MONITORING

(71) Applicants: Micah J. Rosenbloom, New York, NY (US); Edward Tekeian, Cambridge, MA (US); Michael S. Koeris, Natick, MA (US)

(72) Inventors: Micah J. Rosenbloom, New York, NY (US); Edward Tekeian, Cambridge, MA (US); Michael S. Koeris, Natick, MA (US)

(73) Assignee: SAMPLE6 TECHNOLOGIES, INC., Boston, MA (US)

(21) Appl. No.: 13/572,277

(22) Filed: Aug. 10, 2012

(51) Int. Cl. G06F 17/18; G06Q 10/06

(52) U.S. Cl. 705/7.28; 702/19

(57) ABSTRACT

Methods and systems are provided herein for monitoring pathogens in various environments and on various items, wherein data from monitoring is trackable, analyzable and comparable versus various standards or thresholds. The methods and systems disclosed herein also include a platform for managing the detection and reporting of pathogens across a number of locations within a number of environments, and using such detection for a wide variety of purposes.

### BACKGROUND OF THE INVENTION

The results from various environmental sampling and detection methods are typically presented to users in ways that are not always real-time or actionable. In addition, the results are not always delivered in a way that renders them trackable, analyzable or comparable versus various standards or thresholds. Thus, a need for an on-line system for real-time or near real-time monitoring and analytics exists. Such a system could be used in combination with rapid, reliable in situ sampling methods to provide an on-site environmental monitoring platform.

Methods and systems exist for detecting pathogens, such as Listeria, Salmonella and E. coli, that create health hazards in foods, food preparation/food service environments, and other environments including hospitals, universities, any manufacturing facility where environmental pathogens are controlled and related facilities. Such methods and systems suffer from a number of drawbacks, including the need in most cases to remove a potentially infected sample from the environment in which it is taken to a laboratory environment, where the sample is placed in a culture environment for enrichment and growth over a long period of time, ranging from many hours to days. Additionally, because these labs are frequently offsite there is a delay in the shipping of a sample to a laboratory. Once enriched, samples are typically viewed with very expensive equipment, traditional culturing methods, PCR and other methods. Thus, current processes are expensive and there is a large time lag between sampling and a result, during which time the sampled conditions may have changed, and the sampled item, such as a perishable food, may no longer be viable or already consumed. A need exists for rapid, reliable, in situ sampling methods and systems. Additionally, a need exists for a system that can distinguish live from dead cells and a system that can be used to validate a facility pre start-up (post-cleaning), in-process or both.

### SUMMARY

Methods and systems are provided herein for detecting, reporting, monitoring, and analyzing the presence of contaminants or other environmental factors, such as pathogens, in various environments and on various items. One such method of detection involves the production of luciferase, Green Fluorescent Protein (GFP), NanoLuc™, or other screenable marker induced in a pathogen by the introduction of a genetically engineered phage into an environment. In certain embodiments, the methods and systems include rapid detection of very low levels of pathogens, down to a small number of cells, in a real world environment, such as a food production environment, and without enrichment of the sample that potentially contains a pathogen. The methods and systems disclosed herein also include a platform for managing the detection and reporting of contaminants or other environmental factors, such as pathogens, across a number of locations within a number of environments, and using such detection for a wide variety of purposes. Such purposes may include, but are not limited to, planning a corrective action, scheduling a follow-up test, mapping a contamination trend, ensuring compliance in testing, providing a report, informing logistics in shipping quarantined inventory, and many more purposes.

In an aspect, a platform may include a reader for real time, in situ measurements of a pathogen presence in a food preparation environment, wherein the measurement is based on detection of a phage-induced product. In certain embodiments, the measurement may be performed on the production floor itself, sometimes in a small lab in the same facility, and sometimes completely off-site as in a centralized or third-party lab. In any event, a database may be used to store the measurements and a dashboard may be used to report the measurements, for interacting with the measurements, and scheduling and performing operations associated with the measurements. The platform may be capable of detecting and reporting the presence of distinct pathogens or distinct strains of a given pathogen. The platform is capable of quantifying and reporting a level of a given pathogen corresponding with a predetermined set of levels of risk.

In an aspect, a platform may include at least one module for detecting pathogens in an environment based on the detection of a phage-induced product and at least one module for detecting at least one other factor relevant to the safety of the environment. The other factor may be at least one of an (Adenosine Triphosphate) ATP level in the environment, a pathogen measured by another type of detector, a temperature of a sample, a time, a colony forming unit (CFU) count, a sample location, pathogen test results of finished product and a sample frequency. The module may also detect how the sample was collected and who collected the sample.

In an aspect, a platform may include at least one module for detecting pathogens in an environment based on the presence of a phage-induced product and a processor for predicting areas that should be examined based on longitudinal testing data collected by the at least one module, and suggest when during the day to take a sample. Beyond predicting areas, the platform may also be used to track trends and integrate this information with knowledge of the environment to suggest where contamination may be coming from.

In an aspect, an analytic platform may include a reader for collecting a stream of real time data about the presence of pathogens in an environment via any diagnostic assay, a dashboard for reporting the stream of real time data about the presence of pathogens in an environment, a processor for analyzing the stream of real time data about the presence of pathogens in an environment and a reader manager for managing the stream of real time data about the presence of pathogens in an environment. The environment may be a food production environment. The platform may further include modeling the environment in software to track pathogen growth in areas of interest. The platform may further include displaying the tracked pathogen growth associated with their physical locations (a “heat map” of status points) that is dynamically generated through software. The platform may further include integrating a result of the modeling with a Hazard Analysis and Critical Control Points (HACCP) program, environmental control plans, sanitation plans and the validation of those plans. The platform may further include modeling the environment in software to track risk factors in areas of interest, where pathogens may be transient or may form growth niches.

In an aspect, a platform may report detected levels of engineered-phage-induced products of one or more pathogens for enabling at least one of an alert, a report, and an action related to the management of pathogen activity in an environment.

In an aspect, a method of monitoring an environment, includes digitizing a facility floorplan in software, establishing a test point on the facility floorplan, determining a sampling schedule for the test point based on a business rule, mapping a particular diagnostic test to the test point in accordance with the business rule, wherein the diagnostic test is used to sample the test point according to the sampling schedule, and aggregating results from a plurality of samplings at the test point over a period of time in order to monitor the environment. Detecting a biological agent via the sampling performed at the test point may be done using the diagnostic test mapped to the test point. Analyzing the results of the plurality of samplings may be done to determine at least one of a trend, a risk profile, a contamination pattern, and a predicted contamination pattern. Analyzing results from the plurality of samplings may be done to determine a corrective action to ameliorate an environmental condition. The corrective action's effect on the environmental condition may be tracked through sampling. Analyzing results from the plurality of samplings may be done to suggest a preventive action to minimize the occurrence of pathogens and improve at least one of product quality, environmental safety and environmental hygiene. A report of the results of the plurality of samplings may be prepared.

Analyzing results from the plurality of samplings may be done to determine an adherence to a set of defined characteristics for the environment. An alert may be generated when there is at least one of a flaw in the adherence or a positive test result. Tracking the sampling may be done to determine a characteristic. The characteristic may be a user, a date, a time, a lot #, a pathogen detection, a location, an ambient temperature, and a percent completion.

Adding an additional test point may be done during the execution of the method. Aggregating additional data along with the results from the plurality of samplings may be done using at least one of a pathogen sensor, a sensor array, and a third party data source. The combination of the additional data and results from the plurality of samplings may be analyzed to determine at least one of a trend, a risk profile, a contamination pattern, a predicted contamination pattern, a corrective action to ameliorate an environmental condition, and a preventive action to minimize the occurrence of pathogens and improve a product quality.

Visualizing and interacting with the data based on the results from the plurality of samplings may be done in a dashboard of an environmental monitoring platform. Visualizing may be in the form of a heat map that indicates at least one of a presence of pathogen, a quantity or severity of pathogen, and a pathogen strain type. A user of the dashboard may be granted a level of access to results from the plurality of samplings. The test point locations may be determined by at least one of a geo-location and a manual input. The test point locations may be associated with at least one of an image and a scannable identifier. Sampling may include scanning an identifier associated with the test point. Sampling may include taking an image of the test point location and comparing it to the image associated previously with the test point in order to locate the sampling at the test point. A biological agent may be detected by the sampling via the expression of a phage-induced bioluminescent product. Monitoring the environment may include at least one of detecting and reporting the presence of individual pathogens, multiple distinct pathogens or distinct strains of a given pathogen. Overlaying at least one of a foot traffic pattern, a manufacturing production process, and a flow of processed goods with the test points on the floorplan may be done to determine the impact of a contamination spread within the facility.

In an aspect, a system of an environmental monitoring platform may include a digital facility floorplan comprising at least one test point, a sampling schedule for the test point based on a business rule, a mapping of a particular diagnostic test to the test point in accordance with the business rule, wherein the diagnostic test is used to sample the test point according to the sampling schedule, and a database of results from a plurality of samplings at the test point over a period of time used to monitor the environment. The system may include an analytics facility that analyzes the results of the plurality of samplings to determine at least one of a trend, a risk profile, a contamination pattern, and a predicted contamination pattern. The system may include an analytics facility that analyzes results from the plurality of samplings to determine a corrective action to ameliorate an environmental condition. The system may include an analytics facility that analyzes results from the plurality of samplings to suggest new test points. The system may include an analytics facility that overlays at least one of a foot traffic pattern and a flow of processed goods with the test points on the map to determine the impact of a contamination spread within the facility. The system may include a dashboard of the environmental monitoring platform that visualizes and enables interaction with the results from the plurality of samplings. A user of the dashboard may be granted a level of access to results from the plurality of samplings.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 depicts a block diagram of the system.

FIG. 2 depicts a process flow of the system.

FIG. 3 depicts a block diagram of the system.

FIG. 4 illustrates a workflow method.

FIG. 5 depicts an exemplary dashboard.

FIG. 6 depicts an exemplary floorplan of the user interface.

FIG. 7 depicts a test point details dialog box.

FIG. 8 depicts a remediation log of the user interface.

FIG. 9a depicts a schedule page of the user interface.

FIG. 9b depicts a schedule page of the user interface.

FIG. 10 depicts a reports page of the user interface.

### DETAILED DESCRIPTION

Unless otherwise defined herein, scientific and technical terms used in connection with the present disclosure shall have the meanings that are commonly understood by those of ordinary skill in the art. Further, unless otherwise required by context, singular terms shall include the plural and plural terms shall include the singular. Generally, nomenclatures used in connection with, and techniques of, biochemistry, enzymology, molecular and cellular biology, microbiology, genetics and protein and nucleic acid chemistry and hybridization described herein are those well-known and commonly used in the art. Certain references and other documents cited herein are expressly incorporated herein by reference. In case of conflict, the present specification, including definitions, will control. The materials, methods, and examples are illustrative only and not intended to be limiting.

It is to be understood that the terminology used herein is for the purpose of describing particular embodiments only and is not intended to be limiting. It must be noted that, as used in the specification and the appended claims, the singular forms “a,” “an” and “the” include plural referents unless the context clearly dictates otherwise.

The term “comprising” as used herein is synonymous with “including” or “containing,” and is inclusive or open-ended and does not exclude additional, unrecited members, elements or method steps.

Throughout this Specification, the terms “system”, “hygiene monitoring platform”, “environmental monitoring platform”, “pathogen monitoring platform”, and “platform” may be used interchangeably.

As used herein, the term “in vitro” refers to events that occur in an artificial environment, e.g., in a test tube or reaction vessel, in cell culture, in a Petri dish, etc., rather than within an organism (e.g., animal, plant, or microbe). By contrast, “in situ” refers to a natural environment, without the need for artificial apparatus or materials, such as an environment for storing, transporting, or preparing foods, pharmaceuticals, or other items, a healthcare environment, any environment in which pathogens may grow and potentially infect humans or other animals, hospitals, universities, any manufacturing facility where environmental pathogens are controlled and related facilities. In situ environments may be alternatively referred to as “on-site” environments, reflecting the absence of the need to transport a sample from a natural environment to a separate laboratory environment in order to determine the presence of a pathogen.

As used herein, a “screenable marker” is a detectable label that that can be used as a basis to identify cells that express the marker. Such cells can also be said to have a “screenable phenotype” by virtue of their expression of the screenable marker. Suitable markers include a radiolabel, a fluorescent label, a nuclear magnetic resonance active label, a luminescent label, a chromophore label, a positron emitting isotope for PET scanner, chemiluminescence label, or an enzymatic label. Fluorescent labels include but are not limited to, green fluorescent protein (GFP), fluorescein, and rhodamine. Chemiluminescence labels include but are not limited to, luciferase and β-galactosidase. Enzymatic labels include but are not limited to peroxidase and phosphatase. A histag may also be a detectable label. In some embodiments a heterologous nucleic acid is introduced into a cell and the cell then expresses a protein that is or comprises the label. For example, the introduced nucleic acid can comprise a coding sequence for GFP operatively linked to a regulatory sequence active in the cell.

Engineered phage or a group of engineered phage, working in unison (or phage cocktail) may cause a host (e.g. E. coli, Listeria, Salmonella) to produce a detectable and measurable payload. Herein is described a system, or platform, that leverages bio-illumination phage technology, as described in U.S. Provisional Patent Application No. 61/642,691, entitled Recombinant Phage and Methods, filed May 4, 2012, and detection technology for on-site, phage-based pathogen or hygiene monitoring. U.S. Provisional Patent Application No. 61/642,691, entitled Recombinant Phage and Methods, filed May 4, 2012 is hereby incorporated by reference herein in its entirety, and it is attached hereto as Exhibit A. Exhibit A is hereby incorporated by reference herein in its entirety and constitutes part of this specification. The unique nature of the system provides for near-real time data collection, on-site rapid analysis to provide actionable results, and monitoring without requiring the enrichment of pathogens. The advantage of avoiding enrichment of samples, especially on a production floor, is that it has the potential to introduce a population of screened pathogens into the area. The platform enables testing to go beyond process validation to include continuous monitoring and process control.

Engineered phage may enable target pathogens to express a light emitting enzyme in just a few hours which dramatically increases the turnaround time of results and which in turn enables more testing, the ability to quickly take (and track) remediation activities, and more rapidly assess from where a pathogen may be entering a facility. Target pathogens in a food setting can include—Listeria, Listeria Monocytogenes, Salmonella, E. Coli, E. Coli 0157 and other harmful serotypes or food spoilage organisms. In non-food settings, other bacterial species could be tested for including: Clostridium difficile, Staphylococcus, MRSA, and the like. In certain embodiments, the test may have the capability of multi-plexing various species testing—e.g. test in a single swab for Salmonella and Listeria.

The engineered phage approach has other advantages besides speed including the ability to discern live from dead cells (as a biological infection needs to occur, only alive and potentially harmful cells will be detected) to enable a low false positive rate. The test can be performed on-site because no additional pathogen is needed for detection, no enrichment needed, and it is safe to use on-site. Because it is a self-contained test that doesn't require a technician to have lab experience, the platform features high usability. The sensitivity of phage-based pathogen detection is in line with or exceeds various industry, state, federal, corporate or other standards.

The environmental monitoring system, coupled with very sensitive sensor technology, enables this data to be quickly sent to the database module 104 for the creation of alerts, trend analysis, instructing more tests, generating reports, and the like.

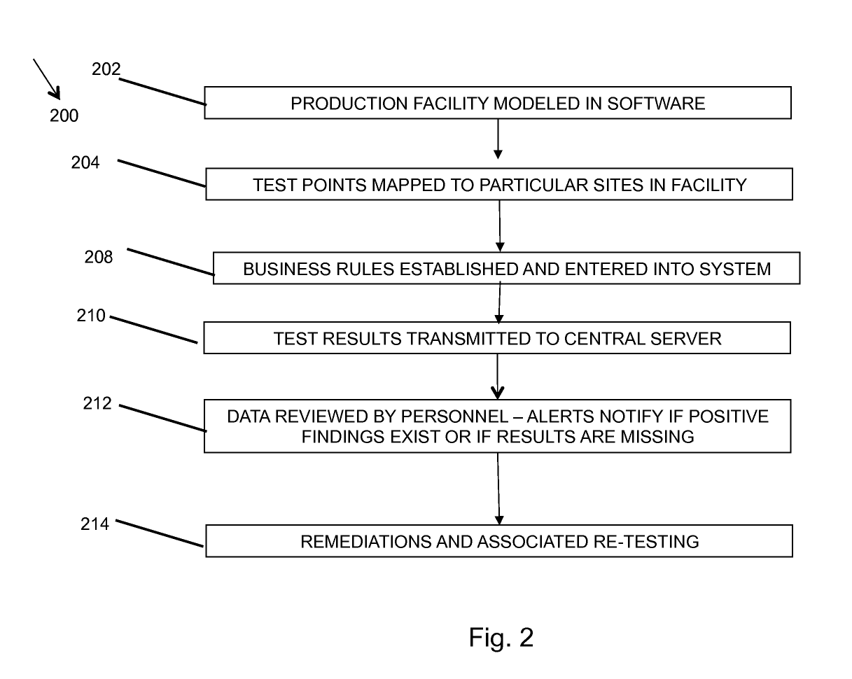

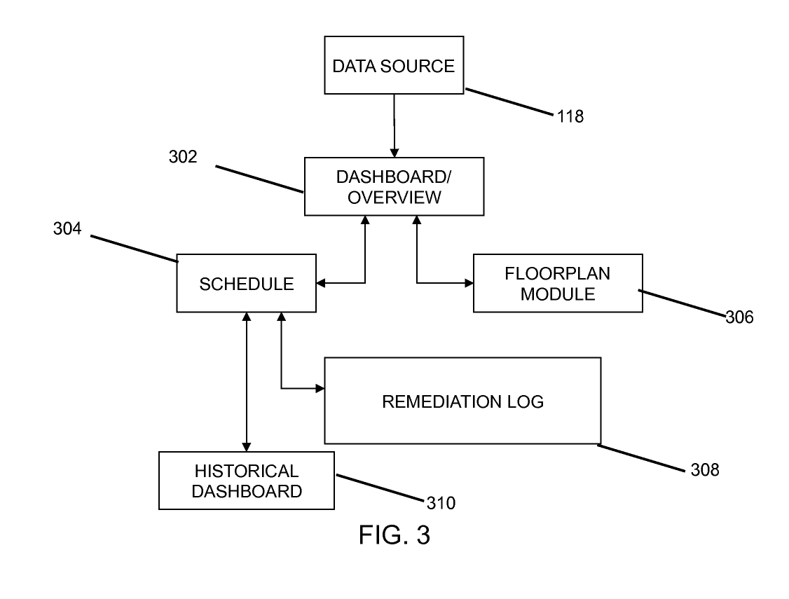

The other advantage of such a system is that it may enable auditors, or QA/food safety personnel to determine where a potential pathogen may originate from by enabling location-tagged testing to assess and determine the root cause of a potential problem. A detailed view of the system and its elements and workflow are presented in FIG. 2 and FIG. 3 described further herein.

In embodiments, the platform may be used as a stand-alone product or may integrate with various dashboards or alert and tracking systems.

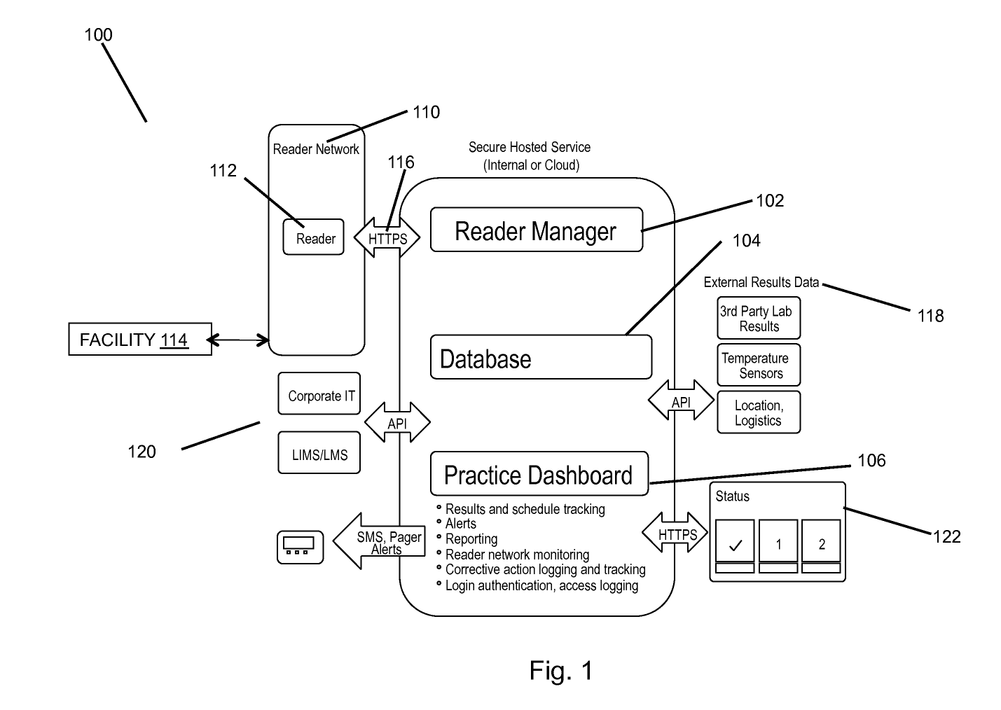

FIG. 1 illustrates a system 100 that leverages bioluminescent phage technology and detection technology for on-site environmental monitoring. It should be understood that while the embodiment described in detail herein uses detection of phage-induced bio-illumination, phages may be engineered to induce the production of a wide range of detectable payloads, and except where context is specific to bio-illumination, the methods and systems disclosed herein should be understood to be capable of application to detection of such other types of payloads. Indeed, the platform may be used to manage, analyze, and report results from a wide variety of assays and is not limited to assay utilizing bioluminescence. Throughout this Specification, the platform may be discussed in terms of managing, analyzing, and reporting results from a bioluminescence assay, but this assay is chosen as exemplary of the kinds of assays useful with the platform.

The system 100 of FIG. 1 can include a reader manager 102, a database 104 and a practice dashboard 106. The reader manager 102 may contain a reader coupled to a reader network 110, which may contain one or more readers 112. In an embodiment, the system 100 may be referred to as an environmental monitoring platform.

In an embodiment, the system 100 may be a secure host service that can be on an internal host or hosted on a cloud server. The system may enable data security, whether data are stored in the cloud or where there is local hosting of data. In embodiments, to secure data, secure system administration policies may be used, hardware-based security may be used, or a combination thereof. For example, an administrator may use the secure system administration policies to set permissions for viewing data by various individual users or groups of users, to set passwords for secure login, and the like. In another example, a user using an iPad to access the platform via an app may use a hardware token to generate a new password for each login, which may be used in conjunction with a multiple-use password.

In an embodiment, a plurality of readers 112 may be placed at various locations throughout a facility 114 for ease of sample read-outs. In other embodiments, sampling kits or stations may be placed at various test point locations throughout a facility for ease of sampling. In an embodiment, the reader 112 may be a pathogen sensor or some other bio-illumination detection system. Alternatively, the readers may be adapted to detect an alternate biological payload from any sort of diagnostic assay. In embodiments, the reader location may include a centralized sample processing center or lab, a third-party food lab, disposed along a production line, at transition points in a facility such as at a doorway, in a warehouse, and the like. In other embodiments, the system may require only one reader 112, which may be a handheld embodiment to monitor a specific location. Throughout this specification, wherever “plurality of readers” or “readers” is indicated, it should be understood that a single reader may also be employed.

Test points may be zone-based. Locations in any zone may be test points. For example, Zone 1 may refer to product contact surfaces, slicers, conveyors, peelers, casing removal, utensils, racks, work tables, production equipment, utensils, and containers. Zone 2 may refer to the exterior of equipment, chill units, framework, equipment housing, floors, aprons, tables, maintenance tools, hoses, and the like. Zone 2 may be adjacent to Zone 1. Zone 3 may refer areas in exposed product rooms that are away from Zone 1 like walls, sinks, forklifts, phones, walls, and floors. Zone 4 may refer to areas outside of rooms in which product is exposed like warehousing, sanitation wash rooms, walls, overhead doors, racks, offices, locker rooms, bathrooms or anything physically separate from the factory floor but where factory workers move to and from. In an embodiment, the environmental monitoring platform may propose various levels of testing based on the aforementioned zones where sampling should take place. In an embodiment, the test point identifiers may be treated with an anti-microbial agent to minimize the risk of introducing contamination. Test points may include, for example, machines, surfaces, finished product, or the like.

In an embodiment, the reader 112 may be configured to transmit various signals represented by element 116 in FIG. 1 to one or more of the reader manager 102, database 104, or practice dashboard 106. The signals 116 may include test results for a particular test point, location of reader, data from other connected sensors, reader device status, reader identification, incoming bulletins and updates for the operator, time/date of tests, operator name or any other information provided to it.

In an embodiment, the reader 112 may be connected, via wireless connection (e.g., Wi-Fi, satellite, or cellular connection), to a secure remote storage that can be located in the same facility, within corporate networks, in a high security cloud configuration, or the like. In an embodiment, the reader manager 102 may be configured to be or include secure remote storage.

In an embodiment, the test or test data may be coded in various formats and may be included in a sample kit for further processing. The reader 112 may be configured to read the type of test and other test data from the sample kit by various means. The various means may include recognizing a code, such as a bar code or QR code, on a sample tube. Test or test data may be coded into an RFID tag integrated into the sample tube. A computer memory may be built into the sample tube to store the test and/or test data.

In an embodiment, test points may be in any Zone. For example, test points may be located at various points on or near a production line so as to cover the most critical areas on the production line where a chance for contamination is maximum or at an interface of two different environments on the production line, such as a conveyor belt, hopper, production line equipment, storage area, handling area, processing area, cleaning area, sterilization area, packing/assembly area, shipping/transportation area, disposal area, contact surfaces, and the like. The reader manager 102 may be configured to continuously monitor contamination across the production line by aggregating data from a plurality of sampling test points. In an embodiment, one test point may be selected to cover a particular area of the production line, while another test point may be selected to measure a different area of the production line and a third test point may be selected to measure a particular area of the production line, and so on and so forth including as many test points as is required so that the entire production line may be covered.

In an embodiment where there are a plurality of readers 112 in a facility, the reader network 110 may be configured to collect data from the plurality of readers 112 and transmit data to the reader manager 102. In an embodiment, each of the plurality of readers 112 may be operably coupled to the reader manager 102 for data transmission. Data transmission may occur via a number of different networking protocols, such as Wi-Fi or hard-wired Ethernet-based transmission of data, IEEE 802.11, Bluetooth, cellular (2G, 3G, 4G, GSM, GPRS, EVDO, and the like), IR, RF, mesh networking, and the like.

In embodiments, the samples may be taken at the various test point locations and read somewhere else in the facility, either on the plant floor or in another room or lab. When the sample is read, data regarding the location from where the sample was taken along (using tags described herein) with the measurement may be transmitted to the database. In yet other embodiments, the reader may be a portable reader or a plug-in module to a portable device so that the user can take samples and measure them immediately. In embodiments, the portable device or reader may transmit data using conventional networking protocols or may store data on a memory for later retrieval. In an embodiment, the system 100 may be in communication with an iPhone or other smartphone, mobile device or tablet to be used as a reader for test swabs. For example, the iPhone/iPad may include an embodiment of the reader as a plug-in module for receiving and analyzing test swabs. In other embodiments, the iPhone/iPad may interface with the reader to improve the testing workflow. For example, after each swab, the iPhone/iPad may capture a read-out, couple time/day/lot # or other pertinent information such as traceability data to the read-out, and send the data to a server by wireless transmission or sync. Various other embodiments of the reader are described herein.

The results collected from testing may be aggregated to enable near real time reporting, such as in a dashboard. Dashboard alerts could be sent to phones, pagers, and other devices to warn a user of the result.

In order to facilitate sampling, the system may monitor an RFID tag on the swab that has a complementary emitter on the zone that is to be swabbed. In an embodiment, the system may work on low power such that the RFID tag must be in the area of the emitter, otherwise an interaction is not recorded. This ensures that user is close to the intended test site. The system 100 may also generate a timestamp when the RFID/emitter interaction is recorded.

The system 100 may be configured to correlate a picture of a test point to the data obtained by the reader or stored in the database module, as described herein for image-based test point location.

In an embodiment, the reader, sampling kit, or sampling station may include a temperature stabilizer for sample tubes storage for tests that require a wait period, a stabilization period, or an acclimation phase. The temperature stabilizer can alert the user when an appropriate sample tube temperature or time/temperature has been reached. In an embodiment, the temperature stabilizer may be battery operated to enable a cordless functionality, or it may be a corded device. In an embodiment, the temperature stabilizer may be a plug-in to the reader. In embodiments, the platform may alert the user that the sample should be placed in the temperature stabilizer, be refrigerated, be frozen, left at room temperature, or the like.

In an embodiment, a reader may be configured for continuous testing of a specific test point. For example, the reader may be configured to be an automated pathogen sensor/monitor with a replaceable cartridge or swab that would periodically sample and report levels of pathogens. The data may be centralized and alerts would be issued in case of high level of pathogen detection. The tests may apply to critical control points, such as particular machinery, health care settings, and the like.

In an embodiment, the reader manager 102 may be configured to interact with the reader network 110 by HTTPS (Hypertext Transfer Protocol Secure) or some other networking technology as described herein. The reader manager 102 may be configured to manage or secure HTTPS connections. The reader manager 102 may be configured for receiving incoming results. The reader manager 102 may be used for receiving device status from at least one of the plurality of readers from the reader network 110. The reader manager 102 may be used to send software updates and system status notifications to the reader network 110.

The reader manager 102 may be configured to send information received from readers to the database module 104 regarding data processing. The database module 104 may be in communication with a third party host 120 including corporate IT or LIMS/LMS (Laboratory Information Management System) via API (Application Programming Interface) protocol.

In an embodiment, the reader 112, data manager platform or database module 104 may be configured to interact with a data source 118, such as through an API or via receiving a raw data dump to be processed and/or visualized. The data source 118 may include data from any kind of assay, a third party lab, temperature or other environmental sensors, location logistics, an ATP hygiene monitoring system, confirmatory test results from lab based test results (e.g. cell culture, PCR, and immunoassay), time and temperature monitoring, process inputs (e.g. air quality and water quality), allergen and toxin monitoring, pest control, RFID, Geo-location, remote QC devices transmitting status via IR, Bluetooth or wireless networking protocols, product codes and lot numbers, traceability data, FDA data, USDA recall lists, HACCP protocols, corrective action/preventive action (CAPA) protocols, corporate GMP updates, and the like. For example, the data from various sources may be aggregated so that there are multiple data streams regarding a particular product, such as test point sampling during production, USDA recalls for a product's starting material, and air quality monitoring. Additionally, anecdotal data may also be included as a data source 118, such as data on hand washing compliance (via video or other systems) to be used for monitoring as well as data from visual inspection reports, such as if standing water were found at a test point.

The database module 104 may be configured to send and receive information from the external data source 118 and the third party host 120. The database module 104 may be configured to receive and integrate data. For example, the database module 104 may receive data from any external results data source, such as those described above, corporate IT and LIMS, or other information management systems and integrate it to generate an interrelated and synchronized output for analysis. In another example, the database module 104 may receive data from a third party lab or other testing used to periodically validate a positive or negative result. In any event, these data could be aggregated by an algorithm that integrates different data sets to provide risk data, trend analysis, predicted contamination analysis, and the like. In an embodiment, the database module 104 may be configured to make and maintain data structures. A database management tool may be used to interact with and maintain the data structures. In an embodiment, the database module 104 may be integrated with cloud systems or mobile systems, such as smartphones. For example, the reader may be adapted to communicate data to a cloud database, either directly or through a reader manager. In another example, a reader may be adapted to deliver results directly to a smartphone, or a smartphone may be adapted to pull data from a reader. In any event, the smartphone may be adapted to store the results in an integral database module, such as an internal memory configured for such purpose. As will be further described herein, the smartphone or other device may also be adapted to, such as by running a mobile application, analyze the results obtained from the reader and perform further downstream functions as an outcome of such results.

The database module 104 may be operably coupled to the reader manager 102 to enable receiving test results data from the reader manager 102. The database module 104 may be configured for data analysis and validation and interacting with the reader manager 102 and the practice dashboard 106. The database module 104 may be configured to assist in root-cause detection of contamination and to determine higher levels of contamination. The database module may also assist in determining cross-contamination in an ongoing process. The data validation and analysis can be done as further described herein with reference to FIG. 2 and FIG. 3.

The database module 102 may be operably coupled to the practice dashboard 106. The practice dashboard 106 may be configured to interact with an application 122 enabling web, device or smartphone access. The practice dashboard 106 may be configured to receive results of data analysis from the database module 104 and visualize the results in the application 122. In an embodiment, the application 122 associated with the practice dashboard may be configured to track test status, results, test schedules, corrective programs, and the like as further described herein.

In certain embodiments, such as in a facility where multiple readers are used with the environmental monitoring platform, each individual reader may only be connected, wirelessly or hard-wired, to other readers or the reader manager without its own connection to the Internet or other network. In this example, the reader manager would aggregate all of the data from the readers and perform further downstream communications, such as to the database module, networks, other reader managers, applications, and the like, as will be further described herein. In certain embodiments, the readers may also comprise an integral reader manager such that the reader/reader manager may be a standalone unit performing the functions of acquiring data and communicating the data. In yet further embodiments, the reader may comprise built-in memory for temporarily or more long-term storage of data, including results, business rules, protocols, calendars, databases, and the like. In this way, the reader/reader manager may be a standalone unit performing the functions of acquiring data, communicating the data, and storing the data. In still further embodiments, the reader may comprise a reader manager, built-in memory, and a processor, wherein the processor may serve the purpose of making a measurement, analyzing the measurement in accordance with business rules or established protocol, generating alerts or other events such as a calendar entry, performing root cause analysis, generally performing analytics, and the like.

In an embodiment, the reader may be configured to tag the location of a test, such as via reading a label, bar code, QR code, MaxiCode, RFID or other means. In an example where samples are taken in a facility and then measured in a separate location, the sample tubes or sample kit may be labeled for tracking convenience. The user may take a sample at a particular location, such as at a slicer, a sink, a refrigerator handle or the like. In the example, the sample may be a swab that is then placed in a sample tube. The sample tube may be labeled, either before sampling or by the user during the sampling process, wherein the label may encode a wide variety of information, such as the sample location, operator, date/time, ambient temperature, and the like. The reader may be adapted to read the label when the tube is placed in the reader for measurement. Data from the sample may be tagged with information from the label and sent together to the reader manager, database module or other downstream system. Sample tube labeling will be further described herein with respect to sample collection kits.

In other embodiments, the label may be at the sampling test point, such as affixed to a piece of machinery or to a wall in an area, and may be need to be scanned when the sample is taken. For example, if the reader is a portable or plug-in device, it may be used to first scan the test point label to obtain test point information to associate with data from the sample. Alternatively, the user may scan the test point label when taking a sample in order to print out sample tube labels. In yet another alternative, the user may simply manually associate sample tubes identified in some way, such as by a separate coding or a location in a sample tube storage box, with a test point label scan.

In another example where the reader is located at or near the sampling test point, the user may take the sample and prepare it for placement in the reader. Information about the location, date/time, environmental sensors, and the like may be automatically added to the data point before transmission from the reader, if the reader is programmed with such information or adapted to obtain such information. The user may input their identity as operator to the reader, such as by swiping a card, using an RFID tag, or manually keying in data. Alternatively, the user may associate themselves with the reader after the sample has been read.

In an embodiment, the system may offer customized views of or customized levels of access to data, alerts, reports, maps, and the like for various interested populations. In an embodiment, the customized views/access may be available via permission or authorization. For example, the reader may report results only to a customer repository without revealing the result on the reader to the test taker to maintain the security of the data. Effectively, the environmental monitoring platform may blind the test “operator” to the results only providing the reviewers (e.g. managers) the ability to see the test results data. In embodiments, the data may be filtered or otherwise censored when delivered to certain populations. In an example of the system running in a food packaging plant, QA/food safety personnel and managers may have all data across time reported to them, but buyers may only receive data from a time period during production of a particular lot. For example, select data may be shared with purchasers of food to validate that the food was produced with specified procedures in place. This can allow retailers and other buyers to determine whether or not to accept a shipment. This would involve giving different “permissions” to various users of the platform.

In embodiments, the system may allow results to be distributed to users who have authority to access the results. For example, various permissions may be set to allow specific users or groups of users to receive notifications regarding particular results, such as via an alert on a smartphone. In an embodiment, notification that test results are ready to read may be sent to one or more users. Notification may be delivered via email, voicemail, text message, smartphone application alert, and the like. The user may then further be able to access the results via a user interface, as described below.

When using the system as an application on a smartphone, the user may be presented with access to a user interface or dashboard, as further described herein, for further details regarding the alert and opportunities to perform downstream tasks, such as initiating a corrective action, sending the alert to another user or group of users, viewing the full dataset, viewing a report, and the like. The practice dashboard 106 may be operably coupled to the reader network 110 via the reader manager 102, the database module, or other platform element. The practice dashboard 106 may be used as a user interface and may provide a login authentication module which may keep track of user activity, login information, schedules, logs, alerts, reports, track status of readers in the network, provide a central location for management of readers, and the like.

The practice dashboard 106 may be used to keep track of all subscription/payment information and details for user access and monitoring as well as for access and monitoring of a service provider.

In an embodiment, the dashboard may be a customizable user interface for authorized users to perform a variety of tasks associated with the environmental monitoring platform, such as initiating a corrective action, sending the alert to another user or group of users, viewing the full dataset, viewing a report, viewing data as a map, viewing a graph, taking a sample, comparing data taken by particular operators, comparing data taken at particular times, monitoring/modifying the status of readers, monitoring/modifying the status of the reader network, view and submit reports of data validation and analysis results and the like. For example, and without limitation, a plant manager's dashboard may have a view of all raw data associated with sampling at the plant. The manager may be able to use a dashboard analysis tool to analyze the data and prepare various floorplans, reports, graphs, heat maps, summaries, emails, and the like. In the example, the manager may view the data as a map/floorplan of a tracked contamination, displaying only positive results on the map over time. The map can be sent to another user. The manager may click on the map to obtain additional details about particular data points displayed on the map.

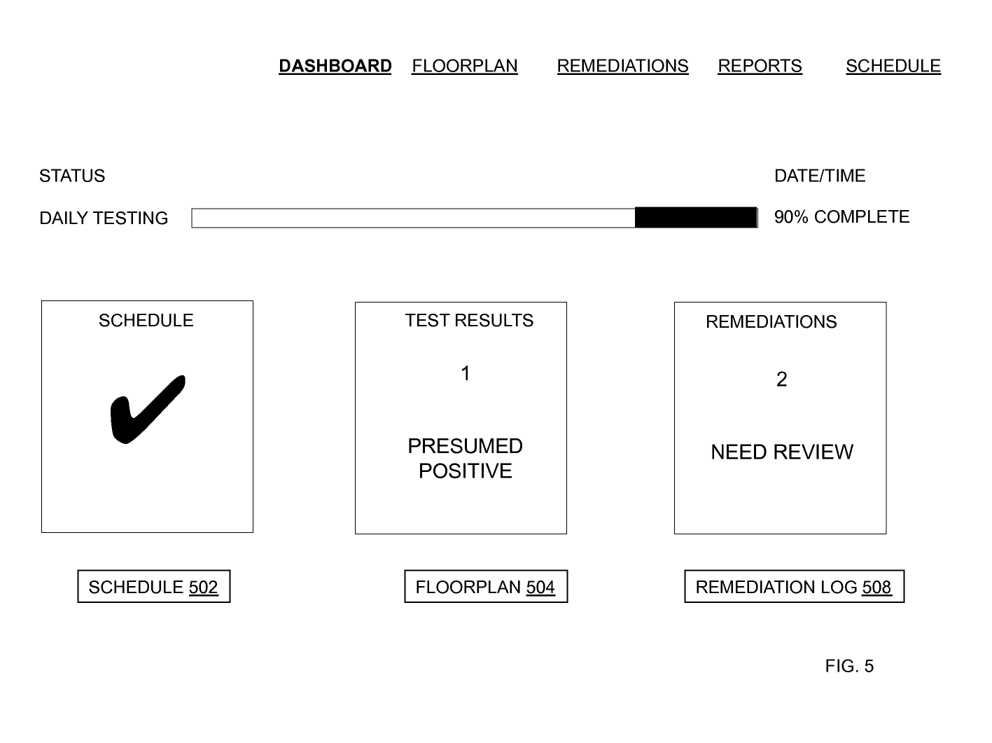

Referring now to FIG. 5, an exemplary dashboard for accessing various aspects of the platform is depicted. Test results may be automatically added to the platform by readers and the reader manager. The dashboard monitors scheduled test taking, results, and corrective actions (which are based on presumed positive test results and includes activities such as clean-up and re-test) on an ongoing basis. The dashboard indicates the overall status of test completion for a time period, such as by a bar graph. The dashboard allows access to a schedule 502, floorplan 504, and remediation/corrective action log 508. In this example, the checkmark for the schedule 502 indicates that all required testing has been completed, is at least partially completed, or is at least not overdue. In this example, there is one presumed positive result and two remediations requiring review.

In an embodiment, the environmental monitoring platform may indicate numerically, via color-coding, or some other indicator the presence/absence of a specific pathogen. In the dashboard feature, tracking of the presence/absence of a specific pathogen may be done over time and be organized by zone or test point, pathogen type of strain or other variables. Alerts, such as SMS, pager alerts, or the like, may be sent to particular users if a positive finding was obtained and the location of the finding. Results can be sent to third parties such as food safety consultants, or to company managers, and the like.

In an embodiment, data may be integrated with an enterprise resource planning (ERP) system, other quality management software, lab management software or other proprietary software.

In an embodiment, the system 100 may be predictive. If positive results are obtained, the system can suggest specific areas to test or re-test. This can be based on test point data taken from sampling process and knowledge of the process as well as the facility 114. Alternatively, the system may require a new sample to be collected for external lab testing. Later, the lab result and the presumed positive are reconciled by the system. The system will alert when a lab result has arrived or when overdue.

Upon receiving a presumptive positive data point, the system 100 can help identify a root cause of contamination. In an embodiment, root cause analysis may be done by Guided Vector Sampling, where the goal is to determine a source of contamination and devise an effective and timely remediation. The system may generate a heat map, or floorplan, centered on the presumed positive test point that is the origin and vector out, or extrapolate, from the positive test point to areas that should be subsequently tested, such as based on a distance from the presumptive positive, an amount of time since the presumptive positive was recorded, a type of contamination recorded at the presumptive positive test point, and the like. The proposed surrounding test points may be weighted based on their test history. For example, areas with test points that have a prior history of a positive test may be more heavily weighted than areas with no history of positive tests. Additionally, the system may propose testing new points not tested in the past or on the schedule to currently be tested. When the platform proposes additional testing, it is creating more test points or guiding the operator to a new combination of existing test points. Test points may have varying longevity. They can be permanent, single use (such as an opportunistic sample) or short duration (such as used during two days of vector sampling).

The locations and volumes of tests may be proposed and tracked by system. The heat map or floorplan may display the weighted results as colors or with some other visual identifier. As data are aggregated, potential areas of contamination should become more and more narrow and specific and the root cause of contamination may be revealed. Historical vector sampling results may be overlaid onto the heat map to indicate both areas of agreement with test history and divergence uncovered during vectoring. In an embodiment, there may be multiple data streams for each test point. For example, additional test data, such as ATP, lab results, finished goods testing, pictures and contextual input, for each test point may be presented either in a parallel view or as added to the weighting. Potential outcomes can include identifying a potential contaminating piece of equipment, human traffic issue, drain or other feature of the facility. Thus, the system may essentially implement a form of containment protocol.

In an embodiment, platform analytics may be used to identify problematic suppliers or product lines. Each test point and its associated test results offers the possibility of granularly assessing whether a certain supplier is supplying contaminated product. Obtaining samples may involve swabbing of food surface itself, food packaging, trucks, receiving areas, non-food contact surfaces (Zone 3/4) and/or food contact surfaces (Zone 1/2). The platform offers the capability of preparing a time-based view of rich data regarding various test points in the context of a floorplan. Such a floorplan may show the time a presumed positive was found and the supplier whose material was present on the line at that time by providing the ability to look at the floorplan in terms of supplier identifiers, such as product codes, that were moving through test points when a particular test point was positive. Thus, the platform can leverage product codes to track specific suppliers, specific lots, product types, and inventory back to positive test results.

In an embodiment, the system 100 may be used to track trends in environmental monitoring over time, such as with a trend analysis tool of the dashboard. The system 100 may monitor and present to a user a set of trends over time to, for example, determine if there is a spike in a particular pathogen during a certain time of year in a certain facility. For example, users may be enabled to compare pathogen contamination trends across multiple facilities for various periods of time. In an embodiment, users may compare data obtained from tests with industry standards. In an embodiment, comparative reports may be generated across various facilities to ensure consistency across a single company, industry, plant, and the like. The data may be used in a macro sense to identify standards across the industry. The data may be useful to the insurance industry, CFOs, or the like, such as by reducing a premium by lowering the risk of pathogen presence in finished products.

In an embodiment, the system 100 may be used to determine potential hazard points or risk as explained further herein.

In an embodiment, the practice dashboard 106 may compare data across multiple facilities or to industry benchmarks. The practice dashboard 106 may compare results to a threshold value, such as an acceptable level of contamination or a threshold for concern. The practice dashboard 106 may be operably coupled to or programmed to generate various indicators. The indicators may be audio, visual, audio-visual, graphical, or spectral in nature. The practice dashboard 106 may be configured to recommend an action to ameliorate contamination. The reporting done by the practice dashboard 106 may be configured to tie the reports to Zones, such as a report for Zones 1-2 which are food contact surfaces, a report for Zones 3-4 which are non food contact surfaces a report for geo-tagged locations, a report for other locations, and the like.

In an embodiment, algorithms may be developed to combine information received from various sources including various data sources 118, a third party host 120, reader network 110 or any other source into an overall food safety risk index to warn users of potential hazards. For example, the data may be weighted as described above. The algorithm may associate data from the various sources, such as by matching data according to the floorplan, according to a geo-location, according to a code, according to a picture, according to a date/time, and the like.

In an embodiment, data from the system may be aggregated and turned into risk models that are sold to the industry, insurance companies, and other interested parties. The data model may be a dynamic “calculator” of sorts that helps with one or more of the following: a) justifying budget to senior management, b) identifying key risk areas, c) helping regulators assess where to focus regulation, d) informing actuary decisions on premium pricing as described previously, and the like. The data used for this purpose may be aggregated from a variety of sources. The sources may include process comparisons across an industry or food type, customer trends, seasonal trends, recall data, pathogen testing data from various food labs, pathogen testing data generated by system 100, testing trends, health data, Pulsenet, or the like.

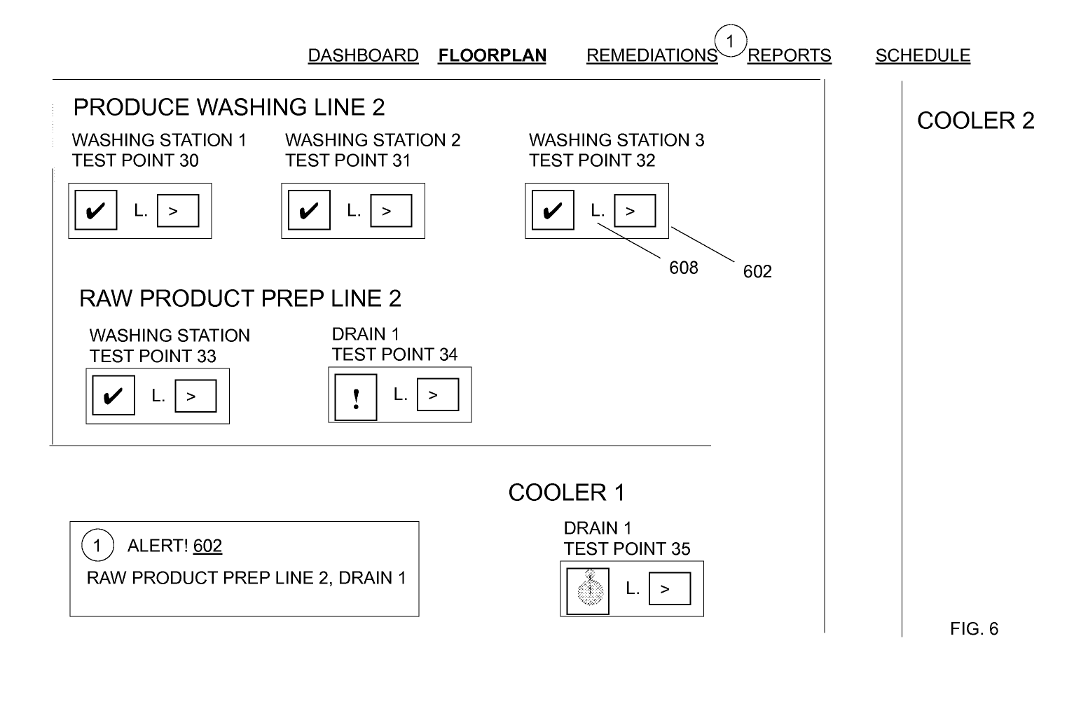

A user may click on the floorplan button 504 to arrive at the view shown in FIG. 6. Referring now to FIG. 6, an exemplary floorplan is depicted. Floorplans may be in a 2D or 3D format and may have critical points highlighted. Creation of the floorplans on the platform may be facilitated by using floorplans provided by the facility or by walking the facility and taking photos and then translating those photos into a layout of the facility. The floorplan may include layouts of major walls, drains, equipment, staff locations, production workflow, human traffic mapping and other relevant visual information about the facility to better enable pathogen monitoring. The floorplans may be stored in the system 100 and may be accessed by the user for reference purpose or to access previous records. In an example where the facility is a food production facility, a 2D or 3D map of the facility indicating locations of all major food contact and non-food contact zones may be created. In embodiments, the floorplan may be a hybrid of 2D or 3D models, with images of test point locations integrated at each marked test point. In an embodiment, the floorplan may be a part of the food production facility's HACCP or CAPA Plan in the form of a part of the prerequisites program, such as to identify potential hazards through critical control points.

The floorplan may be dynamic. For example, the operator has the ability to dynamically add additional test points. For example, as the user reviews the floorplan, the user may randomly decide to add an additional test point to a critical area. Adding the test point may be as simple as touching the location if the user is accessing the floorplan on a device with a touchscreen interface or clicking on the location, such as if the user is accessing the floorplan from a desktop computer. Alternatively, the user may add the new test point by taking a picture of the location to associate with the test point. In any event, the new test points may be tested once or they may be added as points to be tested on an ongoing schedule. In an embodiment, the operator may have unlabeled test kits that can be mapped to the new test point.

While executing the testing schedule, the operator has the option of dynamically adding one or more tests and adding the new test point into the system. Adding a test may generate a dashboard alert and a corrective action, depending on the business rules set. The new test point may be added as follows in an exemplary process. An “unassigned” sample kit is procured. This is a kit where the location data has not been set. The software will recognize the kit as unassigned by scanning the QR code, accessing the computer memory, and the like. With an application, such as a smart phone app, the user adds a new test point. The app may display a live image and asks the operator to align crosshairs on the new test point. The operator takes the image once the crosshairs are aligned. Using the app, the operator is asked to scan the QR code on the unassigned test kit, which associates the sample kit or sample tube with the image just acquired. Either through the app or at a later time, the operator will be prompted to enter details regarding the new test point, such as a descriptive text tag of the new test point, a selection of one or more existing locations that are nearby, whether to add it to the schedule permanently or leave it as a single, opportunistic, sample collection, and the like. The app may alert the operator when a description of the dynamically added test point is incomplete. In other examples of the process for adding the new test point into the system, the process can include geo-locating the smart phone on the new test point to automatically map the new test point with respect to other locations and the facility as a whole. The rest of the process may be unchanged. In yet other examples, the process of adding a new test may commence with clicking anywhere on a floorplan representation, which may prompt the user to add in test details, such as the zone, the test type, the schedule, or an image, and register a sample kit for data tracking, as described above.

As an alternative to geo-located sample collection points, the operator may choose to take an image of each sample site, with the test point at the center of the image. This can be done via a smart phone app or other software processing. If this method is used, the operator has the option of using mobile software to have the schedule presented as a visual floorplan or printing out the daily sample schedule with the test point images described above. This image-based test point location forms a different way to guide daily sample testing, using images and text tags to remind users where to take samples. This is applicable where geo-location or other triangulation services are not available or not robust to the task, or in accordance with operator preference.

In an embodiment, the system 100 may randomly propose test points for sampling. The system 100 may propose new test points by combining one or more of weighting of high risk areas and areas that had been positive in the past in combination with the goal of swabbing an entire facility or area of a facility over some period of time.

Using the visual floorplan with mobile software, the user may click on icons associated with the test point to view an image of the location and read notes on how to collect the sample.

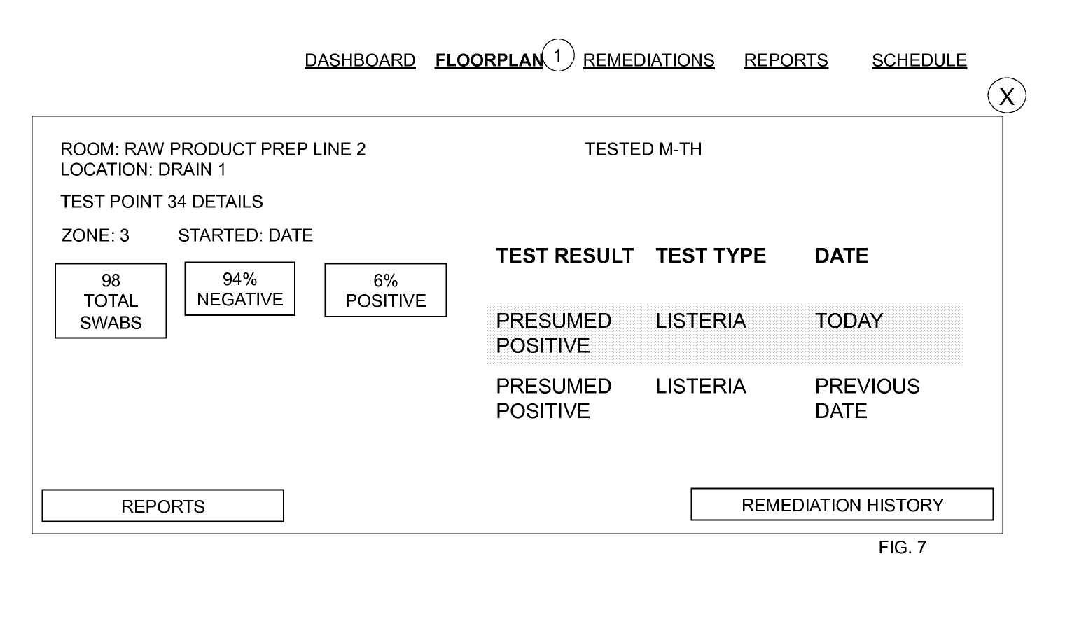

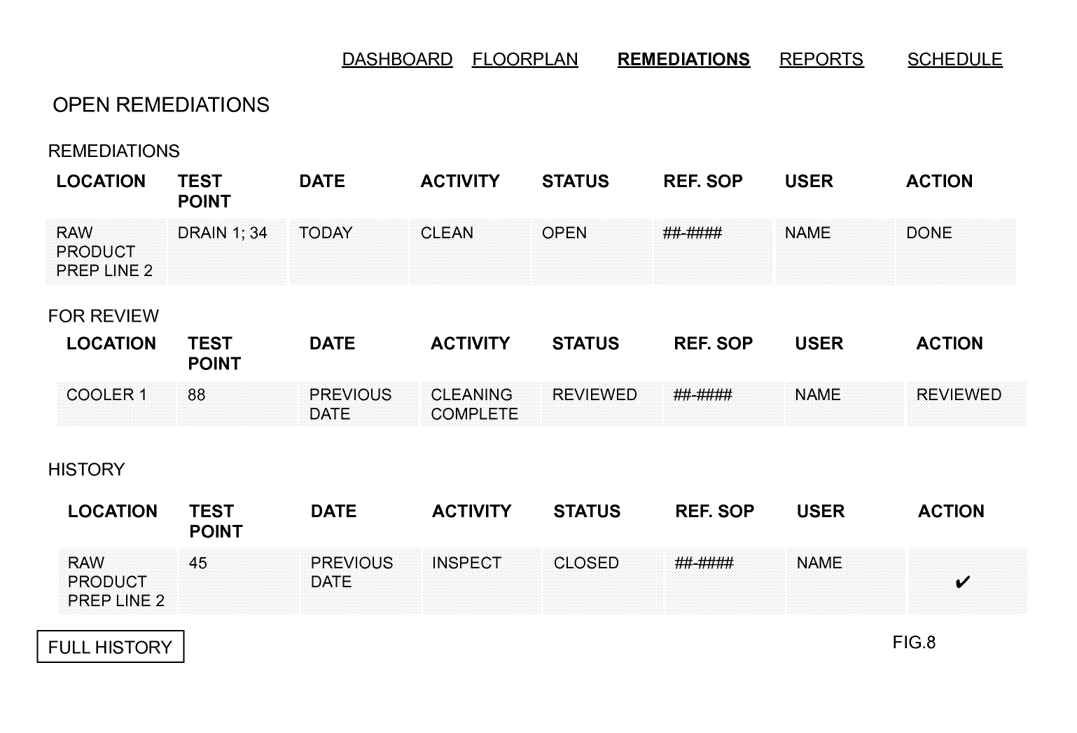

In FIG. 6, details about various washing stations on a produce washing line can be found, as well as a washing station and drain on a raw product prep line and a drain in a cooler unit. Icons 602 may be associated with each test point mapped on the floorplan. The icons 602 may be interactive, as will be described herein. For example, checkmarks may indicate a confirmed negative result, exclamation points may indicate a presumed positive result or a recent history of presumed positive results, a stopwatch may indicate a result is in progress or overdue, and a ‘>’ may indicate that additional details are available by clicking on that icon. It should be understood that any symbol, character, or icon may be used to represent a results status. Icons may also be used to represent the kind of diagnostic test used at the test point. For example, the icon 608 is ‘L.” in FIG. 6 refers to a diagnostic test for Listeria. The floorplan is a depiction of the actual locations of the various test points in the actual facility. In this example, there is one alert indicated for the raw product prep line 2, drain 1. By clicking on an icon 602 associated with that location in the floorplan, the view in FIG. 7 may be accessed. FIG. 7 depicts a dialog box that is displayed when a user interacts with the icon 602. The dialog box displays results and statistics from testing at that particular location, including the results that caused the alert. In this example, data regarding a previous presumed positive result is also displayed. The user can quickly access reports and a remediation log from this view. Additionally, third party data for the test point may be displayed here. Any presumed positive result will automatically cause the generation of a corrective action, which can be accessed in a remediation/corrective action log of the dashboard. FIG. 8 depicts a remediation log. The first entry indicates open remediations, including the location, test point, date, the corrective action required, the status of the corrective action, the standard operating procedure to reference for the corrective action, the user assigned the remediation, and an action button to press upon completion of the task indicating that it is done. By clicking done, the remediation may be moved to the review list. The next line displays data for a remediation that needs to be reviewed by a manager. The entry indicates the location, test point, date, the corrective action indicated, the status of the corrective action review, the reference standard operating procedure, the user assigned the remediation review, and an action button to press upon completion of the review indicating that it has been reviewed. If a remediation is overdue for review, an alert may be generated. Historical remediations may also be viewable in the log.

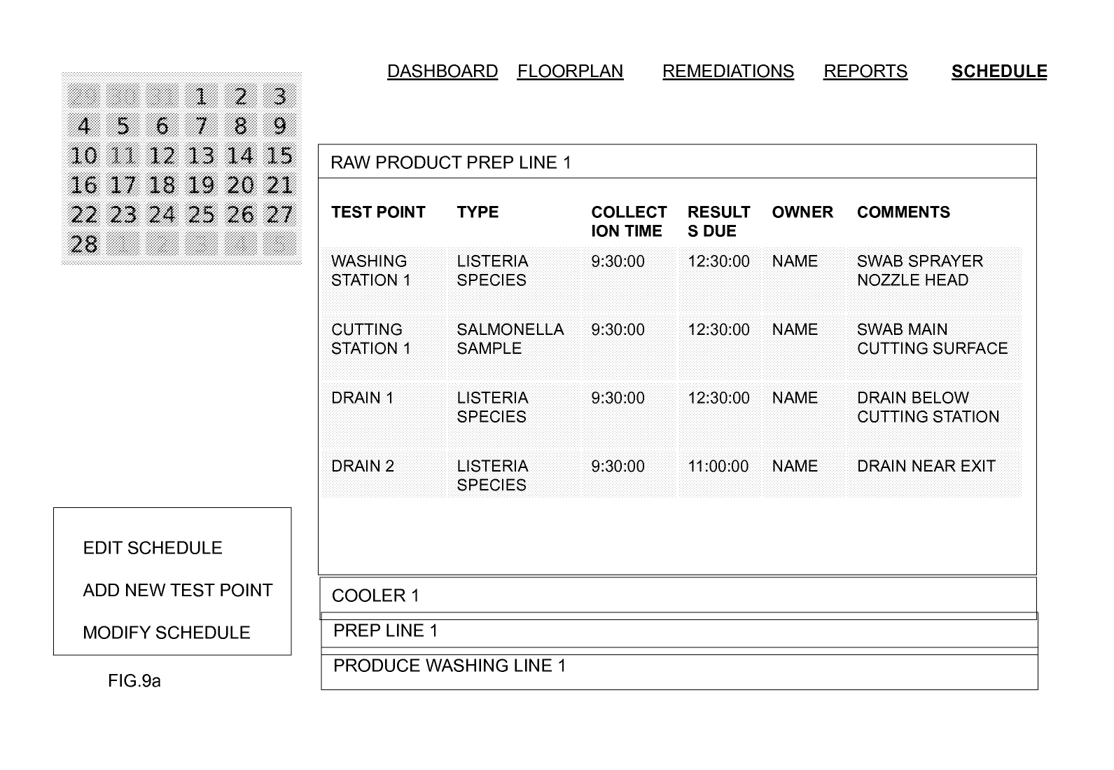

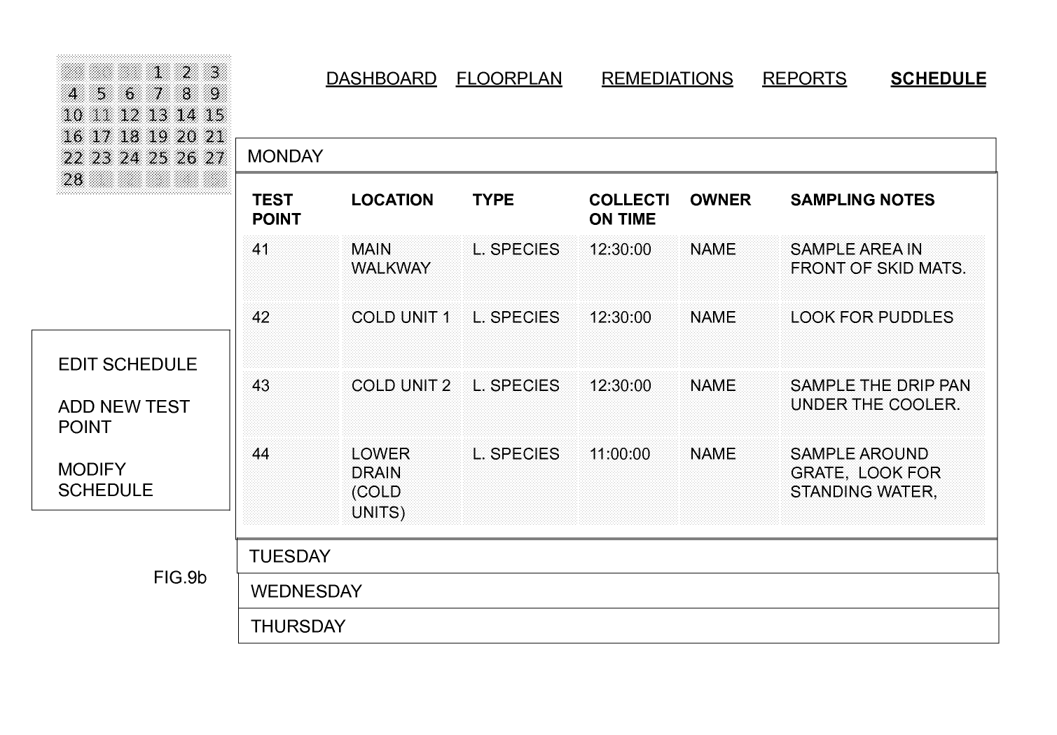

Referring now to FIG. 9A & and FIG. 9B, embodiments of a schedule page of the dashboard are depicted. The schedule page of FIG. 9A allows users to pull up scheduled tests for any particular data at any particular location and review data including the test point, test type, scheduled time, when results are due, the user assigned the testing, and comments. The schedule page of FIG. 9B allows users to pull up scheduled tests for any particular day at any particular test point and review data including the test point, test type, location, collection time, when results are due, the user assigned the testing, and sampling notes. The platform may use the schedule to actively track incoming data to make sure the testing is done on time and it will alert the dashboard when that has not happened. Comments and sampling notes can guide testing to specific locations or can guide users to collect additional data, such as an observed puddle. Such additional data may be added to the data stream for a particular test point. The schedule may feature an accordion view where clicking on a line expands the selection to offer a number of additional lines and enables the user to quickly go through tests scheduled at various locations for the time period indicated, as in FIG. 9A. The accordion view may also be used to review tests scheduled throughout the week, as in FIG. 9B, where each day represents a fold in the accordion view. Using the schedule, new tests can be added at known or randomly selected locations, schedules can be modified, and tests can be randomly inserted at any time. Indeed, if a user adds new tests, such as by using the floorplan interface, the new test point may then appear on the schedule as a test point to be collected now.

Utilizing the schedule, the environmental monitoring platform may track whether or not a sample was collected as planned. The environmental monitoring platform may be programmed to remind users of where and when to take a given sample. Sample collection kits may be pre-printed with test point data (via bar code or other) to alert the user where to take the sample, thus simplifying keeping track of multiple samples. The sample may be geo-located using various methods including GPS, bar codes, QR codes, RFID tags, RF triangulation, and the like. In an embodiment, a GPS or other geo-located method may be used to track where the sample was collected to ensure compliance and consistency in test taking. In an embodiment, an alert may be sent via SMS or other means if a sample was not collected. Tracked data may also include time of sample collection, name of sample collector, and the like. In an embodiment, an identifier, such as a bar code, QR code, or RFID tag, may be placed on test points throughout the plant to be scanned prior to a sampling so that the sampling may be mapped back to the 2D or 3D map of the production facility 114 in software enabling when the test was taken, the specific location of the test, and the like to be tracked. Alternatively, the identifier at the test point may simply be compared to an identifier on the sample kit to ensure that the sample is taken from the correct location.

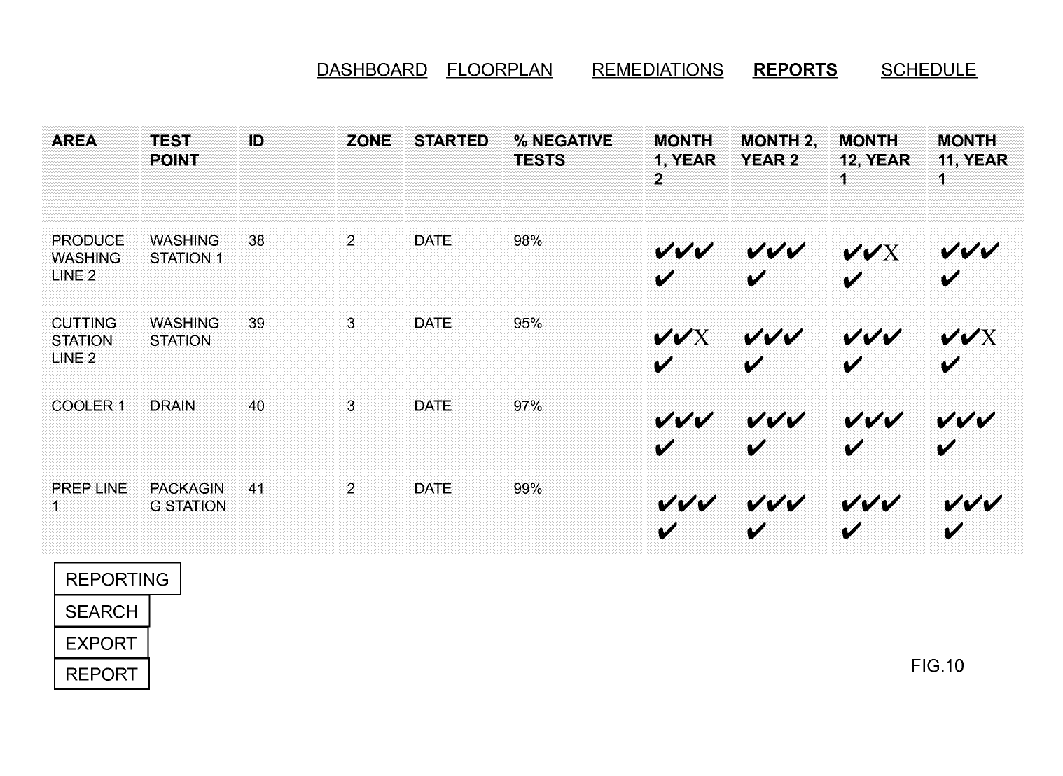

Referring now to FIG. 10, a reports page of the dashboard is depicted. Reports may include historical views of all testing activity. The report output may be fully customizable, may be printed, may be exported to a software application, or interfaced/synced with any corporate IT infrastructure. The reports may include third party data. Reports may be used to track trends and perform analytics. The report may be searchable and exportable. In a embodiment, the report includes data for each test point, including the area, test point number & location, zone, times of testing, % negative tests, % positive tests, actual test results broken down over time, and the like. In this example, checkmarks indicate a negative result and ‘X’ indicates a positive result.

The practice dashboard 106 may be deployed as software, in ticker format, as an application feature in a smartphone or similar device, and the like.

Referring now to FIG. 2, a method 200 for conducting a phage-based detection of pathogens in a given environment by conducting various tests, collecting test data and analyzing the collected data is illustrated. The method 200 may include mapping the production facility 114 or any other environment at step 202 and modeling the environment in software to generate a floorplan, as previously described. The method 200 in step 204 may further map test points to particular sites on the floorplan generated at step 202.

The method 200 may further include establishing a set of “business rules” at step 208 for the platform that sets out various parameters, such as the number of tests to run per day, how often to repeat a sample per test, where the samples should be collected, corrective actions that occur after a presumptive positive result at step 210, the number of negative re-tests required to satisfy a corrective action on a presumed positive result, where to send data, what graphs/tables/reports to produce from the data, thresholds for an alert, how to set a monitoring process, and the like. For example, a rule may be that if a positive result is obtained in Zone 1, the corrective action is re-cleaning of all equipment. In embodiments, users may have the ability to modify or add business rules, review business rules, update business rules, and the like.

The method 200 may include transmitting the test data, either presumed positive or confirmed negative, to a central server at step 210, such as via wireless or Ethernet-based transmission of data or transmission via another networking protocol. In embodiments, data may be stored to a memory of a test reader, such as a removable memory, such that the memory may be removed to another device for review. In an embodiment, information syncs up with the servers or customer servers to maintain data for future issues, tracking trends, audits, etc. The data should be exportable/presentable in a format comparable to other data at the site, to facilitate review by auditors or inspectors. For example, output of data in common formats (Excel, etc.) may be used to form a secure customer repository of test results. In an embodiment, the data may be reviewed by QA, food safety, infection control personnel, or other users. Transmission of results from the reader may be used to monitor usage of the test reader itself.

At step 212, the server may expect a transmission of results on a schedule, so the server may generate an alert when a test has been skipped, or when presumptive positive test results have been received. The reader or the server may alert a 3rd party lab to request or pick-up a sample for additional testing based on the result. In an embodiment, reports and graphs, such as heat maps, may be generated by the system showing areas that have or do not have positive results for pathogens or other contaminant.

The method 200 may further include recommending corrective activities at step 214. The corrective activities may be tracked by the system 100 and re-testing may be done until negative results are obtained. A business rule may govern the number of negative re-tests required to satisfy a corrective action on a presumed positive result.

FIG. 3 is a block diagram representing the system 100 and illustrating functionality layers present in the system 100.

The system 100 may include a data source 118 that feeds data from any number of sources, including bioluminescent assays to detect phage-induced products.

The system 100 may include a dashboard or overview module 302, similar to the practice dashboard 106 previously described herein. The dashboard/overview module may be configured as a user interface and may be configured to interact with the user, send out alerts (e.g. SMS, pager alerts, etc.), interact with APIs/applications, maintain user authentication and logging details in a profile, and the like. The system 100 may include a schedule module 304. The schedule module 304 may be operably coupled to the dashboard/overview module 302. The schedule module 304 may be configured for performing scheduling and tracking tasks of the dashboard, such as to set a specific time for collection of data, a due date for sampling, assigning tasks to certain collectors/operators, and the like.

In an embodiment, the schedule module 304 may, in accordance with the business rules, send reminders when tests are supposed to be taken and by whom. The schedule module 304 may be adapted to determine customized schedules, such as based on a season, based on a shift, based on a user/operator, and the like. The schedule module may also be operably coupled to the database module 104. In an embodiment, scheduling may also include determining what device is to be used, when and at what location. The schedule module may also track when a task was actually performed, if a task is complete, or if a task is incomplete in comparison to when it was scheduled to be performed and what the completed task should have been. This can be used to track performance across a set of employees.

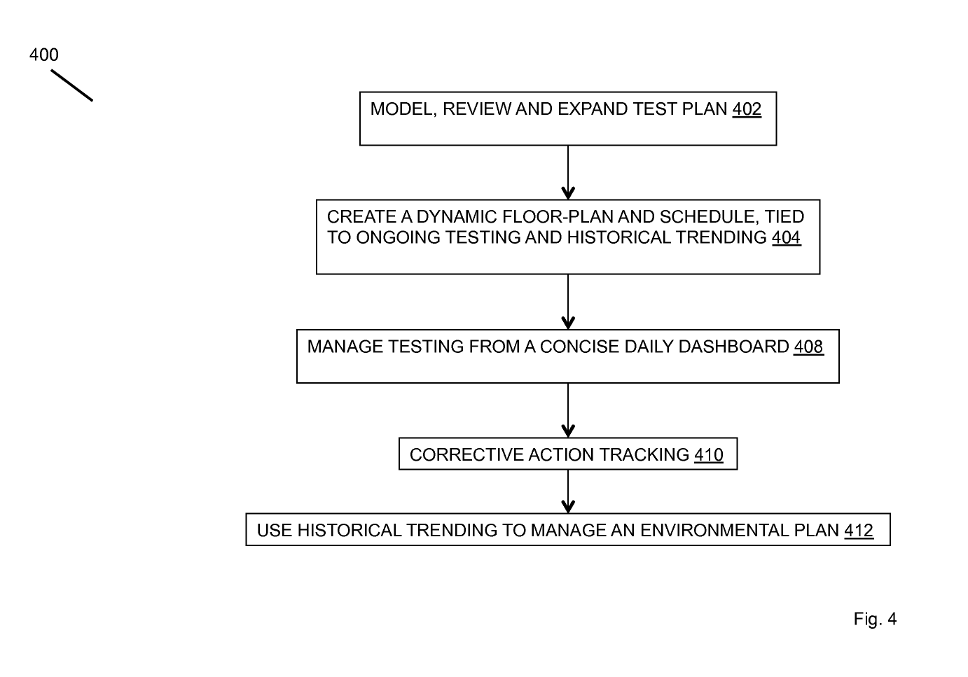

The system 100 may include a floor plan module 306 (also referred to as a heat map generation module 306). The floor plan module 306 may be operably coupled to the dashboard module 302 and the reader manager 102. The floor plan module 306 may be configured to generate a map (as illustrated in FIG. 4) of the production facility. The details about map generation were described previously with reference to FIG. 2. In embodiments, iPads/smart phones may be used with the platform for tracking where a sample was taken. For example, a user could touch a location on a floorplan displayed on the touch screen of the iPad/smart phone and that would tie a certain swab # to a test point. Additionally, an application running on the device could inform the test taker where to take each test, when to take each test, and the like. Photos could be taken by the device, such as photos of the test points to associate with samples, as described herein.

The system 100 may include a corrective action log 308. The corrective action log 308 may be configured to recommend and store corrective actions based on test result analysis. The corrective action log 308 may be coupled to the schedule module 304 to enable synchronizing scheduling and corrective actions. The corrective action log may be used to assign tasks to various operators, managers, and the like. Additionally, the corrective action log may be used to confirm completion of the corrective action upon a follow-up test that returns a negative result. In combination with the business rules, the corrective action log may be used to determine whether certain corrective actions should go into a CAPA system.

The environmental monitoring platform can track when a corrective action is closed by having a negative test at the site of a previous positive (and subsequent corrective action). The corrective action log may be automatically updated or manually updated by a user after a given positive result. The corrective activity may include suggesting separate agents for implementation of the corrective action and review. Alerts may be created if a corrective action has not been performed as mandated or a corrective action has not been reviewed as mandated. In an embodiment, the environmental monitoring platform may recommend a sanitation protocol and potentially which products will be most effective on a given surface. In an embodiment, the environmental monitoring platform may recommend a preventive action to minimize the occurrence of pathogens and improve product quality.

The system 100 may include a historical dashboard 310 that may be configured to record and display previous tests, test results, reports, graphs, maps, and the like for future reference. The historical dashboard allows the user to look across all testing over a specified time period and locations to spot trends (e.g. seasonality) or improvement/non-improvement over time. In embodiments, the historical dashboard may be a dashboard configured to display items from a defined time period.

FIG. 4 illustrates a general workflow method diagram 400 of a phage-based pathogen detection procedure in a food testing environment.

The method 400 may include modeling and reviewing test points on site floor plans of a facility 114 at step 402, and expanding a test plan. The modeling of test points and monitoring may be outsourced to a third party. Test points may be associated with validation or monitoring of critical control points, as identified in an HACCP, environmental or sanitation plan. At step 404, users can create a dynamic floorplan (as depicted in FIG. 6) and schedule (as depicted in FIGS. 9a and 9b), that are tied to ongoing testing and historical trending. At step 408, testing may be managed from a concise daily dashboard, as depicted in FIG. 5. The dashboard may be accessed from any number of devices and may send alerts and notifications to any number of devices, such as smartphones and pagers. At step 410, corrective actions can be tracked, as depicted in the dialog box of FIG. 7 and the remediation log in FIG. 8. At step 412, historical trending, as depicted in FIG. 10, may be used to manage an environmental plan. Data may be exported, or the platform may be integrated with IT infrastructures to facilitate an end-to-end solution for environmental monitoring.

The system 100 may be configured as a passive program wherein a consultant or auditor may come in and document risk points. The consultants may use pictures or a map of the facility 114 and program the system 100 with hotspots. The system 100 may be configured to record and recognize the pictures or map. The consultants may monitor all testing data and results being done in accordance with an HACCP plan to ensure that potential hazards at critical control points are being effectively monitored. In an embodiment, the system 100 may be an ISO-like system such that a type of certification may be given after testing has been done and reports have been found negative of any contamination. A schedule may be set for further testing and certification renewal.

In an embodiment, the system 100 may be used as a platform for real-time or near-time in situ monitoring for a pathogenic presence in a given environment. In an embodiment, the system 100 may be a platform for real-time or near-time monitoring of pathogens in an environment, wherein the platform may be capable of detecting and reporting the presence of distinct pathogens or distinct strains of a given pathogen, depending on the test. Further, samples can be divided for general screening, followed by specific testing.

In an embodiment, the system 100 may be used as a platform for real-time or near-time monitoring of pathogens in an environment, wherein the platform is capable of quantifying and reporting a level of a given pathogen in correspondence with a predetermined set of levels of risk. In an embodiment, the risk levels may be predetermined by the system 100 or input manually.

Near real-time results enable a host of downstream activities. For example, near time results enables in-line processing monitoring so that machines or systems can be immediately taken off-line if pathogens are detected. In an embodiment, actionable information may be generated during cleaning cycles to determine whether re-cleaning is necessary or the system needs to be taken apart for cleaning. In an embodiment, frequent swabbing makes it easier to identify points of contamination, the root cause of a pathogen contamination, and to rule out a putative origin of contamination. Further, a distinction may be drawn between an indigenous contamination or a continuous re-introduction of pathogens from an external source. The system may also help suppliers of chemicals to determine where, when and which cleaning agents to use.

In an embodiment, the environmental monitoring platform may be used to quantify the severity of a problem by correlating a signal to a number of cells (e.g. <10 cells, >100 cells, >1000 cells) and this can be correlated to a particular corrective action, such as re-clean and re-test, taking the facility or part of a facility off-line, quarantining food, destroying food, and the like. In an embodiment, the platform may be useful in distinguishing transfer points from reservoirs, i.e. a surface that has a low count may be considered a transfer point, especially when taken in the proper context.

In an embodiment, the system 100 may be used in combination with other detection technology located in the same facility or in a third party facility.

In an embodiment, the system 100 may be a platform including modules for detecting pathogens in an environment based on phage-induced products and for detecting at least one other factor relevant to the safety of the environment.

In an embodiment, the system 100 may be a platform including modules for detecting pathogens in an environment based on phage-induced products and for detecting at least one of ATP (Adenosine Triphosphate) or other marker of biologic activity, a pathogen measured by another type of detector, temperature of a sample, time, CFU (Colony Forming Unit) counts, sample location, sample frequency, and the like. The system 100 may be configured to compare results obtained from other tests with test results based on phage-induced products gathered by the platform, and to properly associate results from other tests with their platform counterpart, such as via geo-location, coding, or other means). The system may be programmed to recommend a course of action in case the tests based on phage-induced products are positive and at least one of the other detection tests are negative. The system may be programmed to recommend a course of action in case the tests based on phage-induced products are negative and at least one of the other detection tests are positive. In an embodiment, the detection tests based on phage-induced products may be used in conjunction with ATP level tests.

In an embodiment, the system 100 may be used for predicting areas that should be examined or that should come under scrutiny. The system 100 may be a platform including modules for detecting pathogens in an environment based on phage-induced products and for predicting areas that should be examined based on longitudinal testing data.

In an embodiment, the system 100 may be an analytic platform/framework/software environment for collecting, reporting, analyzing and managing a stream of real time data about the presence of pathogens in a plurality of environments.

In an embodiment, the system 100 may be used in food production analytics. The system 100 may be an analytic platform/framework/software environment for collecting, reporting, analyzing and managing a stream of real time data about the presence of pathogens in a food production environment.

In an embodiment, the system 100 may be used in analytics and tracking growth. The system 100 may be an analytic platform/framework/software environment for collecting, reporting, analyzing and managing a stream of real time data about the presence of pathogens in an environment and modeling the environment in software to track pathogen growth in areas of interest.

In an embodiment, the system 100 may be used in analytics, tracking growth and heat maps. The system 100 may be an analytic platform/framework/software environment for collecting, reporting, analyzing and managing a stream of real time data about the presence of pathogens in an environment and modeling the environment in software to track pathogen growth in areas of interest and to display the tracked growth in a heat map representation. In an embodiment, a 2D or 3D map of production facility indicating locations of all major food contact and non-food contact zones may be created. In an embodiment, the map may be a part of a food production facilities HACCP Plan in the form of a part of the prerequisites program. In an embodiment, heat maps may be created showing areas that have or do not have positive results for pathogens. Utilizing location-based access, the history of every test point (both current and previous) may be presented in the heat map, and indeed, any representation of the data, including reports, graphs, and maps.

In an embodiment, the system 100 may be used in analytics, tracking growth and integration. The system 100 may be an analytic platform/framework/software environment for collecting, reporting, analyzing and managing a stream of real time data about the presence of pathogens in an environment, modeling the environment in software to track pathogen growth in areas of interest, and integrating the result with an HACCP program, a CAPA system, and environmental validation plan, a sanitation plan, an existing Lab Management Systems or Enterprise Database, and the like. For example, an HACCP program may involve monitoring the environment at critical control points for all potential hazards. The testing results may be aligned with those tests required for adherence with the HACCP program, which in fact may be fewer points than those actually being taken. Continuing with the example, certain test points may have positive results, but if those test points are not included as a critical control point in an HACCP program, the facility may still adhere to HACCP while having positive test results.

In an embodiment, a lay-out of the facility 114, process flow and protocol tie-in may be mapped by the system 100.

In an embodiment, the system 100 may be used in analytics, tracking growth and determining areas of risk. The system 100 may be an analytic platform/framework/software environment for collecting, reporting, analyzing and managing a stream of real time data about the presence of pathogens in an environment and modeling the environment in software to track risk factors in areas of interest.

In an embodiment, the system 100 may be configured for using all detected data for various purposes. The system 100 may be used for reporting detected levels of engineered-phage-induced products of pathogens for enabling at least one of an alert, a report, and an action related to the management of pathogen activity in an environment. The environment may refer to a setting in which the system 100 may be used.

In an embodiment, the data may be used by the system 100 to recommend a sanitation protocol and potentially which products will be most effective on a given surface.

In an embodiment, a type of branding may be done or a seal may be placed on the outside of boxes, cartons, or packaging of food to convey to purchasers (restaurants, supermarkets, foodservice, etc.) that food safety has been monitored during production.

The branding may contain a QR code or other mechanism that can be scanned to provide detailed production data including: sources of the food—e.g. “Traceability” data, production techniques, health information, ingredients, organic status, expiration information, cooking instructions, lot codes, and the like. The detailed production data may be coupled to the environmental monitoring results data.

In an embodiment, the system 100 may be an integrated turn-key service that may be sold on a subscription basis to an end user. In an embodiment, a turnkey service for food safety monitoring may be sold as a monthly subscription to end consumers or to purchasers such as those at large food service companies, distributors, retailers, and the like. The system 100 may be persistently active to constantly monitor the presence of pathogens, trends, and risks. In an embodiment, the system 100 may be an alarm system, rather than a batch system. The system 100 may be configured for proactive detection and monitoring of pathogens.

Unlike other microbial tests that may be available as individual units, the system 100 may be sold as a complete system that includes the swabs, the reader hardware, data management and alerts, and 3^{rd} party monitoring. In an embodiment, a pricing model may include a certain number of tests per month. In embodiments, all monitoring and other services may be included in the pricing model. The system 100 may be sold through a distributor such as a food lab, cleaning supply company or other vendor. In an embodiment, presumed positive results may be coupled with a service that triggers a secondary swab to be sent to a partner lab for culturing.

The environmental monitoring platform may be usable across the entire food chain to monitor environmental pathogen contamination for both process monitoring and validation of cleaning procedures, HACCP programs, and the like. In an embodiment, the environmental monitoring platform may be used in processing plants such as for meats, fresh-cut produce, seafood, poultry, and the like. In an embodiment, the environmental monitoring platform may be used in retail establishments such as supermarkets (deli counters, fish, ready-to-eat meal production), restaurants, wholesale markets, large food service operators and vendors, food production facilities, import/export establishments, federal and state government inspection services such as US Food and Drug Administration (FDA), US Department of Agriculture (USDA), Food Safety and Inspection Service (FSIS), hospitals, nursing homes, other healthcare settings, and the like.

In an embodiment, the environmental monitoring platform may be used in hospitals, long term care facilities, or private healthcare facilities for monitoring of varied pathogens that may cause Hospital Acquired infections, for example.

In an embodiment, the environmental monitoring platform may be used by universities, cruise ships, kinder and elder care, stadiums, public parks, recreational sporting facilities or locker rooms, or any area where crowding and turnover may be a problem, such as military barracks or vessels, dormitories, summer camp, and the like.

The markets for the environmental monitoring platform may include the food sector (processors, wholesalers, retailers), consumers, retail chains, international food export/import, healthcare facilities, and the like.

Pathogens that may be detected by the environmental monitoring platform may include E. coli, Listeria, Salmonella, campylobacter, specific E. coli subsets (STEC, EHEC, various O&H serotypes like O157:H7, O111:H8, O104:H21, etc.), Vibrio, Shigella, Staphlylococcus, clostridium, cryptosporidium, brucella, corneybacterium, Coxiella, Plesionomas, Yersinia, Aeromonas, or any pathogen which is controlled or monitored in a production environment, including any bacteria which is considered an indicator for the presence of another pathogen.

The system 100 may also be used to detect specific spoilage organisms (SSO). The presence of SSO may be useful in identifying batches of food that may be prone to spoilage. These batches may be re-treated in order to obtain better shelf life and less spoilage.

In an embodiment, the environmental monitoring platform may be used by QA or food safety personnel at a user site, a 3^{rd} party auditor, an infection control/nurse, a cleaning crew, and the like. In an embodiment, the environmental monitoring platform may be used to monitor pathogens to provide actionable data to users and other relevant personnel.

The environmental monitoring platform may be used in finished product testing, as depicted in FIG. 2, once the finished product has been processed into a state that is amenable to be read by a reader. In an embodiment, the state may be a mostly aqueous solution that may be achieved after grinding up of a sample and separating out the particulates with a fine filter, provided there is no micelle formation or colloids that decrease the transmission coefficient. In an embodiment, existing/standard lab methods for finished product sample prep may be utilized. In an embodiment, the finished product-testing regime may be used to substantially decrease the holding time for finished products and thereby enable increases in shelf life.

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather to provide an understandable description of the invention.

The terms “a” or “an,” as used herein, are defined as one or more than one. The term “another,” as used herein, is defined as at least a second or more. The terms “including” and/or “having”, as used herein, are defined as comprising (i.e., open transition). The term “coupled” or “operatively coupled,” as used herein, is defined as connected, although not necessarily directly and mechanically.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, cloud servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, cloud servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1-35. (canceled)

36. A method of monitoring a facility for contamination by a pathogen, comprising:
A) digitizing a facility floor plan in software;
B) establishing a test point on the facility floor plan;
C) determining a sampling schedule for the test point based on a business rule;
D) mapping a diagnostic test to the test point in accordance with the business rule;
E) performing the diagnostic test on a plurality of samples from the test point, the diagnostic test comprising:
i) providing a sample from the test point;
ii) introducing an engineered phage to the sample without enrichment of pathogen cells present in the sample; and
iii) detecting production of a biological agent produced by the pathogen as a result of infection of the pathogen by the phage; wherein the introducing and detecting are performed within a single production facility within a single production shift; and
F) aggregating results from the diagnostic tests on the plurality of samplings at the test point over a period of time in order to monitor the environment.

37. The method of claim 36, wherein an engineered phage cocktail is introduced into the sample.

38. The method of claim 36, wherein the biological agent is a protein.

39. The method of claim 38, wherein the protein is luciferase.

40. The method of claim 36, wherein the results from the diagnostic tests on the plurality of samplings at the test point over a period of time are aggregated using a computer processor.

41. The method of claim 36, further comprising analyzing the results of the plurality of samplings to determine at least one of a trend, a risk profile, a contamination pattern, and a predicted contamination pattern.

42. The method of claim 36, further comprising, analyzing results from the plurality of samplings to determine a corrective action to ameliorate an environmental condition of the facility.

43. The method of claim 36, further comprising tracking the corrective action's effect on the environmental condition of the facility through sampling.

44. The method of claim 36, further comprising analyzing results from the plurality of samplings to suggest a preventive action to minimize the occurrence of pathogens and improve at least one of product quality, facility safety and facility hygiene.

45. The method of claim 36, further comprising analyzing results from the plurality of samplings to determine an adherence to a set of defined characteristics for the environment.

46. The method of claim 45, further comprising generating an alert when there is at least one of a flaw in the adherence or a positive test result.

47. The method of claim 36, further comprising tracking the sampling to determine a characteristic.

48. The method of claim 36, further comprising adding an additional test point during the execution of the method.

49. The method of claim 36, further comprising aggregating additional data along with the results from the plurality of samplings from at least one of a pathogen sensor, a sensor array, and a third party data source.

50. The method of claim 49, wherein the combination of the additional data and results from the plurality of samplings are analyzed to determine at least one of a trend, a risk profile, a contamination pattern, a predicted contamination pattern, a corrective action to ameliorate an environmental condition, and a preventive action to minimize the occurrence of pathogens and improve a product quality.

51. The method of claim 36, further comprising visualizing and interacting with the data based on the results from the plurality of samplings in a dashboard of an environmental monitoring platform.

52. The method of claim 36, wherein the test point locations are determined by at least one of a geo-location and a manual input.

53. The method of claim 36, wherein the test point locations are associated with at least one of an image and a scannable identifier.

54. The method of claim 53, wherein sampling includes scanning an identifier associated with the test point.

55. The method of claim 53, wherein sampling includes taking an image of the test point location and comparing it to the image associated previously with the test point in order to locate the sampling at the test point.

56. The method of claim 36, wherein monitoring the environment comprises at least one of detecting and reporting the presence of at least one of individual pathogens, multiple distinct pathogens and distinct strains of a pathogen.

57. The method of claim 36, further comprising, overlaying at least one of a foot traffic pattern and a flow of processed goods with the test points on the floor plan to determine the impact of a contamination spread within the facility.
